(19) United States
(12) Patent Application Publication
(10) Pub. No.: US 2025/0341989 A1
(43) Pub. Date: Nov. 6, 2025

(54) NON-TRANSITORY COMPUTER-READABLE STORAGE MEDIUM STORING INSTRUCTIONS IMPLEMENTING SUPPORTING PROGRAM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Yushi ICHIKAWA, Nagoya (JP); Airi EGUCHI, Ichinomiya (JP)

(21) Appl. No.: 19/273,375

(22) Filed: Jul. 18, 2025

Related U.S. Application Data
(63) Continuation of application No. PCT/JP2024/000575, filed on Jan. 12, 2024.

(30) Foreign Application Priority Data
Jan. 20, 2023 (JP) 2023-007199

(51) Int. Cl. G06F 3/12; G06T 3/40

(52) U.S. Cl. CPC G06F 3/1204; G06F 3/1205; G06F 3/1228; G06F 3/1287; G06T 3/40

(57) ABSTRACT

A supporting program for a printer, when executed by a controller of an information processing device, causes the information processing device connectable to the printer to receive a scaling factor by displaying a setting screen on the user interface for specifying the scaling factor. When a universal printing program receives a print instruction from an application program, the supporting program causes the information processing device to obtain a scaled image by scaling the image to be printed based on the scaling factor, and cause the printer to print the obtained scaled image.

### REFERENCE TO RELATED APPLICATIONS

This is a continuation application of International Application No. PCT/JP2024/000575 filed on Jan. 12, 2024, which claims priority from Japanese Patent Application No. 2023-007199 filed on Jan. 20, 2023. The entire contents of the aforementioned applications are incorporated herein by reference.

### BACKGROUND ART

Some known techniques have been developed for controlling a printer using an information processing device, such as a personal computer. For example, one technique involves enlarging or reducing, or scaling an image to be printed to a specific size using a scaling function of a printer driver provided by a printer vendor.

### SUMMARY

Another technique may involve controlling a printer using an OS-standard universal printing program that is part of an operating system (OS), without a printer driver provided by a printer vendor. More specifically, for example, in response to detecting a printer, the OS may establish association between the printer and the OS-standard universal printing program. Thereafter, in response to the OS receiving a print instruction for the printer, the OS-standard universal printing program may generate print data without a printer driver provided by a printer vendor, thereby enabling printing through the OS-standard universal printing program.

Nevertheless, the OS-standard universal printing program might not have a function of scaling an image to be printed to a specific size, which a printer driver provided by a printer vendor has.

According to an aspect of the disclosure, a non-transitory computer-readable storage medium for an information processing device is provided, which includes a controller and stores computer-executable instructions that are executable by the controller. The computer-executable instructions implement a supporting program for a printer connectable to the information processing device. The supporting program, when executed by the controller, causes the information processing device to perform receiving a scaling factor, the receiving including displaying a setting screen on a user interface of the information processing device to allow specification of the scaling factor through the setting screen. The information processing device has an operating system including a universal printing program. The information processing device is incorporated with an application program. In response to the universal printing program receiving, from the application program, a print instruction that causes the printer to perform printing, the supporting program, when executed by the controller, causes the information processing device to perform obtaining a scaled image, the scaled image being obtained by scaling an image to be printed based on the scaling factor, and causing the printer to print the obtained scaled image.

The supporting program receives a scaling factor via the setting screen. In response to the universal printing program included in an OS of the information processing device receiving a print instruction to cause the printer to print an image, the information processing device causes the printer to print a scaled image that has been enlarged or reduced based on the received scaling factor. With this configuration, even when the information processing device has the OS-standard universal printing program but does not have a printer driver, the information processing device can cause the printer to print an image that has been enlarged or reduced to a size specified by a user.

Information processing devices having the supporting program is installed, non-transitory computer-readable storage media storing the supporting program, control methods for implementing the functions of the supporting program, and printing systems including the supporting program and a printer may also have novelty and utility.

According to aspects of the disclosure, a technique of scaling an image to be printed to a specific size may be implemented in an information processing device in which an OS-standard universal printing program is installed.

### BRIEF DESCRIPTION OF THE DRAWINGS

FIG. 1 is a block diagram schematically illustrating an electrical configuration of a personal computer.

FIG. 2 is a sequence diagram illustrating an example of a print settings specifying procedure.

FIG. 3 illustrates an example of a print settings screen.

FIG. 4 illustrates an example of an advanced settings screen.

FIG. 5 is a sequence diagram illustrating an example of a print execution procedure.

FIG. 6 is a flowchart illustrating an example of a data processing procedure.

### DESCRIPTION

Hereinafter, a personal computer (“PC”) using a supporting program of an illustrative embodiment will be described in detail with reference to the accompanying drawings. The disclosure discloses the supporting program executed by the PC.

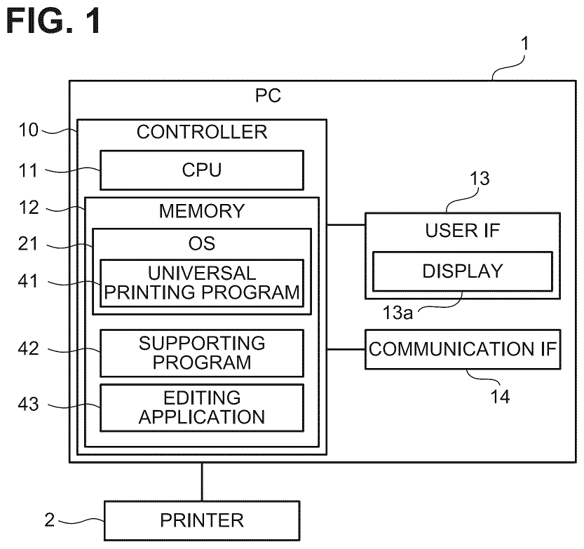

As illustrated in FIG. 1, a PC 1 of the illustrative embodiment includes a controller 10 including a CPU 11 and a memory 12. The PC 1 is an example of an information processing device. The CPU 11 is an example of a computer. The PC 1 includes a user interface (“user IF”) 13 and a communication interface (“communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and data. The memory 12 also serves as a workspace for processing. A buffer of the CPU 11 is an example of the memory 12. Examples of the memory 12 further include storage media readable and writable by the CPU 11, for example, recording media such as CD-ROMs and DVD-ROMs, as well as a ROM, a RAM, a hard disk drive built in the PC 1.

The user IF 13 includes a display 13a, which is hardware for displaying information to a user. Further, the user IF 13 includes hardware for user input. In one example, the user IF 13 may be a combination of the display 13a and an input device, such as a mouse and/or a keyboard. In another example, the user IF 13 may be a touch screen having both display and input functions.

The communication IF 14 includes hardware that enables the PC 1 to communicate with an external device such as the printer 2. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various data and programs, including an operating system (“OS”) 21, a supporting program 42, and an editing application 43. The OS 21 includes a universal printing program 41. The supporting program 42 is an example of a supporting program. The editing application 43 is an example of an application program.

The OS 21 may be a multitasking OS that manages multiple tasks and switches between the multiple tasks, thereby handling several tasks simultaneously. The OS 21 may be, for example, Windows, macOS, Linux, iOS, or Android. Windows is a trademark of the Microsoft group of companies. macOS is a trademark of Apple Inc., registered in the U.S. and other countries and regions. Linux is the registered trademark of Linus Torvalds in the U.S. and other countries. IOS is a trademark or registered trademark of Cisco Systems, Inc. in the U.S. and other countries and is used under license. Android is a registered trademark of Google LLC.

The OS 21 includes the universal printing program 41. The universal printing program 41 is an OS-standard program that is developed by a vendor of the OS 21 and provided as part of the OS 21. The universal printing program 41 is designed to allow for the absence of printer-specific drivers.

The universal printing program 41 enables various types and models of printers provided by different vendors to perform printing based on user instructions. The universal printing program 41 supports general functions that enable various printers to perform printing. Unlike printer-specific drivers, the universal printing program 41 does not support a specific function that a printer or printer driver has, in particular, a function requiring complicated processing.

The universal printing program 41 includes a function of generating intermediate image data based on image data received as data to be printed that has been specified in a print instruction received from an application, based on a user instruction. The intermediate image data may be, for example, data in XPS format. “XPS” is an abbreviation for XML Paper Specification. The universal printing program 41 further has a function of generating print data in a format available for printing by various types of printers based on the intermediate image data. The print data may be, for example, PWG Raster data or PDF data. The universal printing program 41 further has a function of transmitting the generated print data to a printer designated as a device for printing, using a communication function of the OS 21.

The supporting program 42 consists of a single program or a group of programs that execute processing based on an instruction received from the OS 21 in association with the processing executed by the universal printing program 41, and that support control of target hardware. The supporting program 42 is provided for the model of the printer 2 connected to the PC 1, for example, by the vendor of the printer 2. The universal printing program 41 activates the supporting program 42 for the printer 2 based on a specific condition. The specific condition may be, for example, the designation of the printer 2 as a device for printing, the reception of an instruction to specify advanced print settings while the printer 2 is designated, or the reception of an instruction to cause the printer 2 to perform printing. The supporting program 42 may be, for example, a Print Support Application (“PSA”) or a Hardware Support Application (“HSA”).

In one example, the supporting program 42 may be a combination of a plurality of programs that receive execution commands, respectively. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models. For example, when a particular printer is connected to the PC 1 for the first time, the OS 21 of the PC 1 may download a supporting program appropriate for the type or model of the printer from a server of the vendor of the printer, and install the supporting program on the PC 1. The OS 21 stores identification data of the installed supporting program into the memory 12 in association with printer data of the newly connected printer.

The editing application 43 may be, for example, a program for creating and editing image data and/or document data. The editing application 43 may be, for example, Microsoft Word or Microsoft PowerPoint developed by Microsoft or may be a program provided by the vendor of the printer 2. Microsoft, Microsoft PowePoint, and Microsoft Word are trademarks of the Microsoft group of companies. The editing application 43 may receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user's request.

As illustrated in FIG. 1, the PC 1 of the illustrative embodiment is connected to the printer 2 via the communication IF 14. The printer 2 has at least a printing function and a communication function. For example, in response to receiving print data from the PC 1, the printer 2 may perform printing based on the received print data.

Next, a printing procedure performed by the PC 1 of the illustrative embodiment will be described with reference to sequence diagrams. Processing executed in each step in the illustrative embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms referring to coming into possession are used as a concept that does not require necessarily a request to obtain that possession.

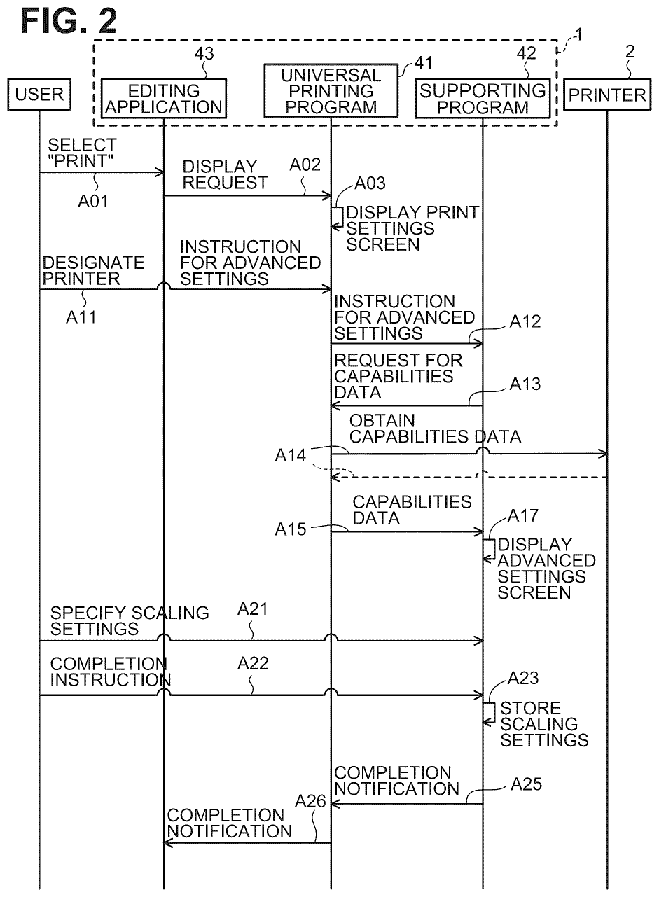

Reference to FIG. 2, a print settings specifying procedure will be described. The print settings specifying procedure is a part of the overall printing procedure. The editing application 43 allows the user to create or edit documents and images. In a case where the user is to print a document or image being displayed, the user selects “Print” on the editing application 43 (A01). For example, the user may select “Print” from a menu of operation items listed in the editing application 43.

In response to the user selecting “Print”, the editing application 43 requests the universal printing program 41 of the OS 21 to display a screen that allows the user to input an instruction relating to printing (A02). In response to the display request, the universal printing program 41 displays a print settings screen on the user IF 13 (A03). The print settings screen allows the user to specify print settings that are available to the universal printing program 41. In other embodiments, for example, displaying the print settings screen may be implemented by the editing application 43.

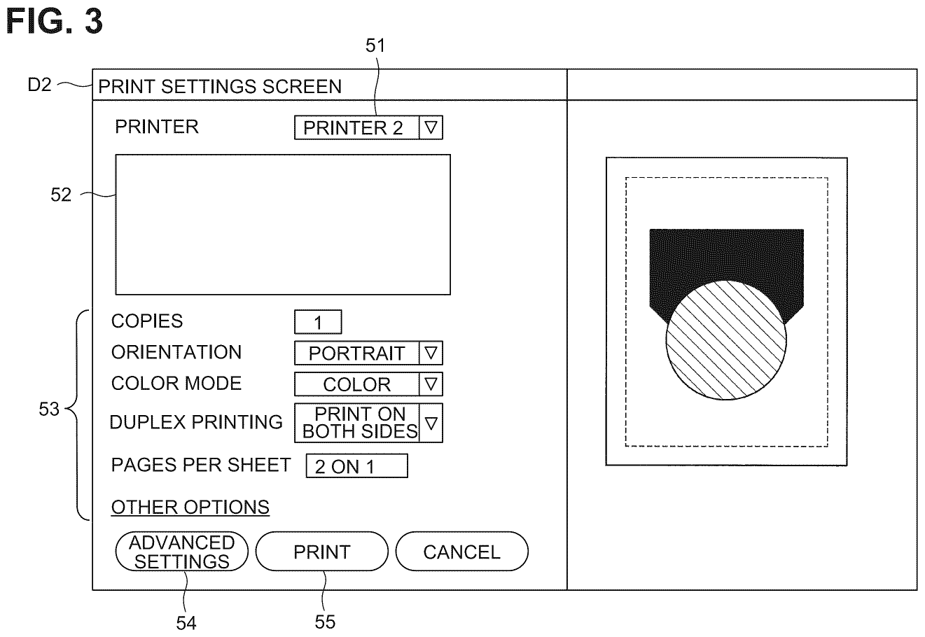

FIG. 3 illustrates an example of the print settings screen. An example print settings screen D2 includes a printer selection field 51, an information display field 52, basic print settings specification fields 53, an “advanced settings” button 54, and a “print” button 55. The printer selection field 51 allows the user to designate a device for printing. The information display field 52 displays information specified by the supporting program 42 for the device designated in the printer selection field 51. For example, in response to the designation of the printer 2 in the printer selection field 51 or in response to the reception of a print instruction through the “print” button 55 while the printer 2 is set as the default printer in the OS 21, the universal printing program 41 activates the supporting program 42 and displays an image prepared by the supporting program 42 in the information display field 52.

The basic print settings specification fields 53 allow the user to specify the basic settings such as the number of copies and page orientation. The “advanced settings” button 54 allows the user to activate advanced settings, including settings that are not included in the basic print settings specification fields 53. The “print” button 55 allows the user to activate printing under the specified print settings.

For example, in response to the advanced settings being activated through the “advanced settings” button 54 while the printer 2 is designated as the device for printing in the printer selection field 51 (A11), the universal printing program 41 transmits an instruction to the supporting program 42 for the printer 2 to start allowing the user to specify the advanced print settings (A12).

After the supporting program 42 is activated in response to receiving the instruction in step A12, the supporting program 42 obtains capabilities data of the printer 2. More specifically, the supporting program 42 requests the universal printing program 41 to obtain the capabilities data (A13). In response to receiving the request, the universal printing program 41 transmits a command to the printer 2 to request the capabilities data from the printer 2 (A14). The universal printing program 41 then passes the obtained capabilities data to the supporting program 42 (A15). The supporting program 42 thus obtains the capabilities data of the printer 2.

In step A14, the universal printing program 41 performs communication with the printer 2 via the OS 21 in accordance with, for example, the Internet Printing Protocol (“IPP”). In other embodiments, for example, the supporting program 42 may obtain the capabilities data directly from the printer 2 using, for example, the Management Information Base (“MIB”), instead of obtaining the capability data via the universal printing program 41.

The capabilities data obtained from the printer 2 includes parameters that can be specified as print settings. The capabilities data may further include, for example, remaining life of consumables, available trays, sheet sizes specified for trays, and available print resolutions. In other embodiments, for example, the printer 2 may have a function of performing image processing based on a received print job and performing printing using image data obtained from the image processing. The printing enabled by this function may be, for example, N-in-one printing, embedded printing such as printing with a watermark, or colorant saving printing. In a case where the printer 2 has an image processing function, the printer 2 may include the capability of the image processing in the capabilities data when providing the capabilities data to the supporting program 42 directly or indirectly. The printer 2 may provide the capabilities data including a status of the printer 2 to the supporting program 42 directly or indirectly.

Based on the obtained capabilities data, the supporting program 42 displays an advanced settings screen on the user IF 13 (A17). The advanced settings screen allows the user to specify advanced settings. The advanced settings screen displayed by the supporting program 42 includes parameters as options that the printer 2 supports. The supporting program 42 allows the user to specify one or more options through the displayed advanced settings screen. The advanced settings screen includes a relatively large number of settings for printing. Therefore, the advanced settings screen may include, for example, tabs that enable the user to switch between different setting items. The supporting program 42 may thus allow the user to select options by navigating through the tabs.

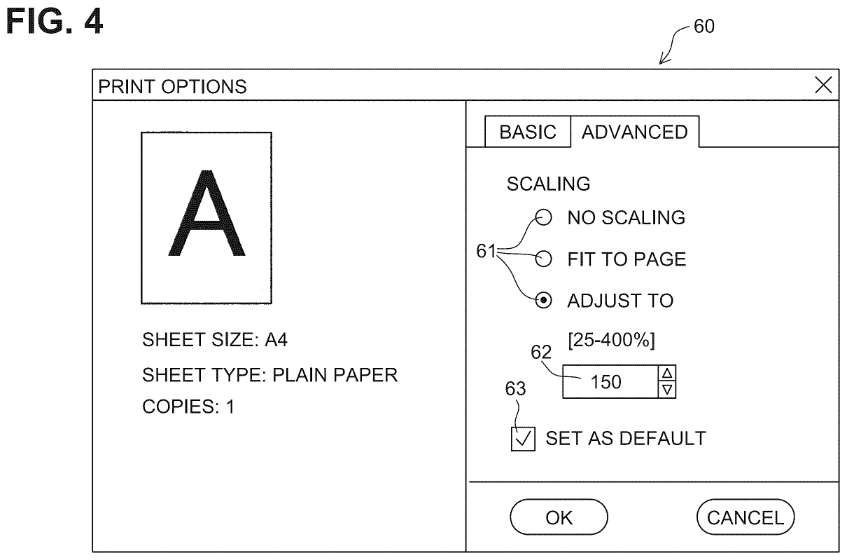

The supporting program 42 may activate scaling settings in response to a user request for scaling settings. The scaling settings are used for scaled printing in which an enlarged or reduced image is printed. In response to receiving the request for scaling settings, the supporting program 42 displays, on the user IF 13, a screen that allows the user to specify one or more options for the scaling settings. FIG. 4 illustrates an advanced settings screen 60, which is an example of such a screen. The supporting program 42 allows the user to specify an option through the displayed advanced settings screen 60. The advanced settings screen 60 is an example of a setting screen.

The advanced settings screen 60 includes radio buttons 61 that allow the user to select one of options for the scaling settings. The radio buttons 61 represent “No Scaling”, “Fit to Page”, and “Adjust to”, respectively. Selecting “No Scaling” activates a function of printing at a scaling factor of 100%. In other words, an image is to be printed without being enlarged or reduced. Selecting “Fit to Page” activates a function of automatically scaling an image to a size that fits the sheet size specified for the tray designated as the sheet source. Selecting “Adjust to” activates a function of scaling an image at the scaling factor specified by the user.

Selecting “Adjust to” allows the user to input a specific value in a scaling factor field 62. The scaling factor field 62 allows the user to specify any value for the scaling factor, for example, within a range of 25 to 400%. The value options for the scaling factor are not predetermined scaling factors specified for standard-sized sheets. The user is allowed to specify any value for the scaling factor within the range, for example, in increments of 1%. Allowing the user to specify a scaling factor in the scaling factor field 62 is an example of receiving a scaling factor.

The advanced settings screen 60 further includes a check box 63. The check box 63 allows the user to indicate whether the scaling factor specified on the advanced settings screen 60 is retained as default settings. The supporting program 42 allows the user to specify an option whether the scaling factor specified in the scaling factor field 62 is retained as the default settings, through the check box 63 on the advanced settings screen 60.

Referring back to FIG. 2, the user provides an instruction to finalize and end the print settings including the scaling settings, for example, by selecting an “OK” button on the advanced settings screen 60. More specifically, receiving a completion instruction to complete the print settings from the user (A22) after the scaling settings are specified (A21) causes the supporting program 42 to dismiss the advanced settings screen 60 and store the specified print settings (A23).

For example, the supporting program 42 stores the status of whether the scaled printing is enabled as the scaling settings. Further, in a case where “Adjust to” is selected, the supporting program 42 stores the scaling factor specified in the scaling factor field 62 and the status of the check box 63. In a case where “Adjust to” is selected and “100%” is specified in the scaling factor field 62, the supporting program 42 might not necessarily store the specified scaling factor, and may store the option indicating no scaling.

Then, the supporting program 42 provides a completion notification that the specification of the advanced settings has been completed to the universal printing program 41 (A25). Based on the completion notification from the supporting program 42, the universal printing program 41 provides a completion notification that the specification of the print settings has been completed to the editing application 43 (A26). In other embodiments, for example, the supporting program 42 may provide the print settings completion notification directly to the editing application 43. The editing application 43 thus activates the print settings screen (e.g., the print settings screen D2 of FIG. 3) displayed in step A03, thereby allowing the user to input instructions, such as an instruction to perform printing or an instruction to cancel printing.

As described above, the print settings screen D2 (refer to FIG. 3) includes the information display field 52 capable of displaying an image generated by the supporting program 42. In response to receiving user input in the information display field 52, the universal printing program 41 passes details of the input to the supporting program 42. For example, the supporting program 42 displays, in the information display field 52, a screen that allows the user to specify the scaling settings. The supporting program 42 thus allows the user to specify the scaling settings through such a screen in the information display field 52. In this case, also as with step A23, the supporting program 42 stores the scaling settings.

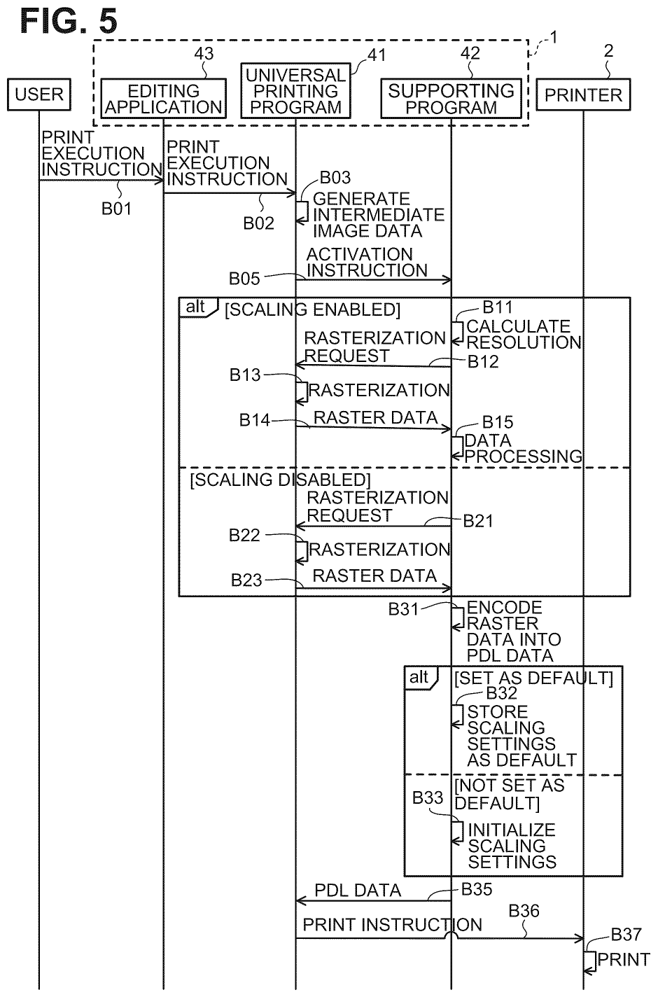

Next, a print execution procedure will be described with reference to FIG. 5. After finalizing the image to be printed and the print settings for the printer 2, the user issues a print execution instruction via the editing application 43 (B01). More specifically, for example, based on the user's selection of the “Print” button 55 in the print settings screen D2 of FIG. 3, the editing application 43 determines that a print execution instruction for the universal printing program 41 has been received. The print execution instruction instructs the printer 2 to print the specified image.

The editing application 43 passes the details of the print execution instruction to the universal printing program 41 (B02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (B03). The image data included in the editing application 43 is of various types. The universal printing program 41 thus converts the received image data to intermediate image data suitable for generating print data. Nevertheless, in other embodiments, for example, when the received image data is in a suitable format, the generation of intermediate image data may be omitted, and the image data may be used as intermediate image data without any conversion.

Prior to generating the intermediate image data, the universal printing program 41 may activate the supporting program 42 for the designated device, which may be the printer 2, and notify that processing for a print job has been started. In a case where the supporting program 42 is activated by the universal printing program 41, the supporting program 42 is allowed to pass various instructions to be used in the generation of intermediate image data, to the universal printing program 41 as necessary.

After generating the intermediate image data, the universal printing program 41 activates the supporting program 42 (B05). The supporting program 42 may obtain the intermediate image data generated by the universal printing program 41 by requesting the intermediate image data from the universal printing program 41. Then, the supporting program 42 may modify the intermediate image data and the print settings received from the universal printing program 41 based on the received print settings.

In response to receiving the activation instruction in step B05, the supporting program 42 determines whether the settings for scaled printing are stored as the scaling settings. As described above, in a case where the scaling settings are specified in the advanced settings, the supporting program 42 stores the specified scaling settings in step A23 of FIG. 2.

In a case where the supporting program 42 determines that the settings for scaled printing are stored (alt: [Scaling Enabled]), the supporting program 42 calculates resolution for rasterization based on the stored scaling settings (B11). For example, the supporting program 42 calculates the resolution for rasterization by multiplying an output resolution of the printer 2 by the stored scaling factor. The resolution for rasterization calculated in step B12 is an example of a parameter. The stored scaling factor is included in the user's instruction received in step A21 of FIG. 2. The output resolution of the printer 2 is obtained from, for example, the capabilities data of the printer 2.

The supporting program 42 passes the intermediate image data and the calculated resolution for rasterization to the universal printing program 41, and requests the universal printing program 41 to rasterize the intermediate image data at the resolution for rasterization (B12). In response to the request, the universal printing program 41 rasterizes the intermediate image data generated in step B03 at the resolution for rasterization to generate raster data (B13). The raster data may be bitmap data. The universal printing program 41 then passes the generated raster data to the supporting program 42 (B14). Thus, the supporting program 42 obtains the raster data scaled at the scaling factor specified by the user. Step B14 is an example of obtaining a scaled image. The raster data obtained in step B14 is an example of a scaled image.

The supporting program 42 requests the universal printing program 41 to rasterize the intermediate image data at the resolution for rasterization that is a parameter reflecting the scaling factor specified by the user, thereby obtaining raster data scaled at the scaling factor specified by the user. Such a configuration may thus eliminate the need for the supporting program 42 to have a scaling function, thereby simplifying the configuration of the supporting program 42.

In the illustrative embodiment, the supporting program 42 requests the universal printing program 41 to rasterize intermediate image data at a specified resolution for rasterization. Nevertheless, in other embodiments, for example, the universal printing program 41 may handle rasterization without scaling, while the supporting program 42 may handle scaling. More specifically, in one example, the supporting program 42 requests the universal printing program 41 to perform rasterization at the output resolution of the printer 2 in step B12. In another example, the supporting program 42 requests the universal printing program 41 to perform rasterization without specifying the resolution for rasterization in step B12. Then, the supporting program 42 scales up or down the raster data received from the universal printing program 41 in step B14 based on the stored scaling factor. Such a configuration may thus also enable the supporting program 42 to obtain the raster data scaled based on the scaling factor specified by the user.

In still other embodiments, for example, the supporting program 42 may perform rasterization instead of the universal printing program 41. More specifically, the supporting program 42 rasterizes the intermediate image data included in the received print execution instruction, and then scales up or down the intermediate image data to generate raster data. The supporting program 42 may provide greater flexibility in rasterization than the universal printing program 41, which is likely to result in raster data that is suitable for printing by the printer 2.

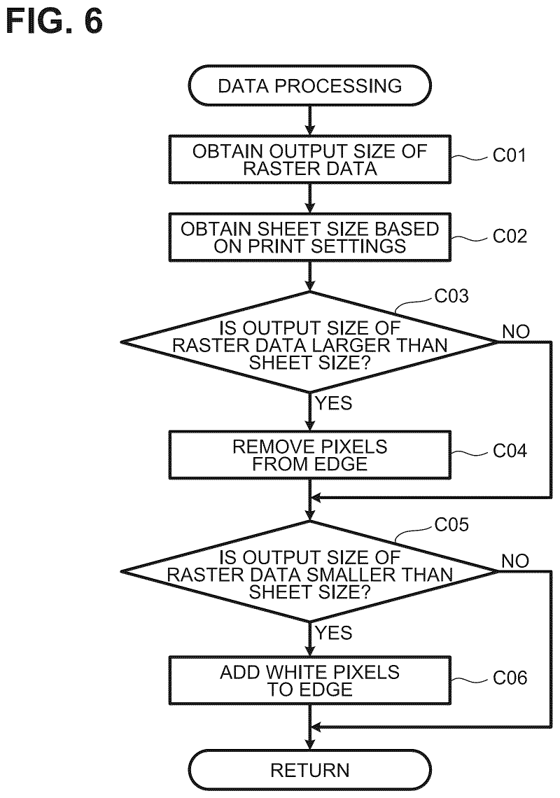

Subsequent to step B14, the supporting program 42 executes data processing (B15). A data processing procedure will be described with reference to FIG. 6. The data processing is executed by the CPU 11 of the PC 1 based on the supporting program 42.

In the data processing, the CPU 11 obtains an output size of the raster data obtained in step B14 of FIG. 5 (C01). Then, the CPU 11 obtains a sheet size based on the received print settings (C02). The CPU 11 compares the output size of the raster data obtained in step C01 with the sheet size. The sheet size is not limited to the size based on the print settings, but may be, for example, a size specified for or detected in a tray designated as the sheet source in the print settings.

If the CPU 11 determines that the output size of the raster data is larger than the obtained sheet size (C03: YES), the CPU 11 removes pixels from an edge, for example, the right or bottom edge, of the raster data (CO4). If the CPU 11 determines that the output size of the raster data is smaller than the obtained sheet size (C05: YES), the CPU 11 adds white pixels to an edge, for example, the right or bottom edge, of the raster data (C06). The CPU 11 executes appropriate steps from steps C03 to C06 for the raster image data in both row and column directions. Such a control may thus enable the output size of the raster data to be adjusted to fit the size of the sheet to be used without changing the size of the image represented by the raster data. Providing the raster data whose size has been adjusted to fit the sheet size to the printer 2 may reduce an occurrence of an output error in the printer 2.

After completion of step C06, the CPU 11 ends the data processing. If the CPU 11 determines that the output size of the raster data is equal to the sheet size (C03: NO and C05: NO), the CPU 11 ends the data processing without adjusting the output size of the raster data. After the data processing is completed, the sequence moves to the next step in the procedure of FIG. 5.

In the illustrative embodiment, pixels are removed from and/or white pixels are added to the right or bottom edge of the raster data. Nevertheless, in other embodiments, for example, pixels may be removed and/or white pixels may be added to the left and/or upper edge, or equally to both left and right edges, or equally to both top and bottom edges. In other embodiments, for example, the supporting program 42 may allow the user to specify a part to be processed in the raster data. In still other embodiments, for example, the supporting program 42 may allow the user to specify the location of the image to be printed in a page through a preview showing the image represented by the raster data and a page of the sheet to be used.

Referring back to FIG. 5, the print execution procedure will be further described. In a case where the supporting program 42 does not store the scaling settings (alt: [Scaling Disabled]), the supporting program 42 requests the universal printing program 41 to perform rasterization without specifying the resolution for rasterization (B21). The universal printing program 41 performs rasterization based on the output resolution of the printer 2, which is a standard resolution for the printer 2, in response to the rasterization request that does not include the resolution for rasterization (B22). After that, the universal printing program 41 passes the generated raster data to the supporting program 42 (B23).

In the illustrative embodiment, the supporting program 42 requests the universal printing program 41 to perform rasterization in step B12 or B21. Nevertheless, in other embodiments, for example, the supporting program 42 may perform rasterization. However, rasterization by the universal printing program 41 may enable the supporting program 42 to execute less processing, and may reduce the program size of the supporting program 42.

The supporting program 42 encodes the received raster data into page description language (“PDL”) data based on the print settings (B31). The received raster data may be the data that has been processed in step B15 or the data received in step B23. The PDL data may be in any format that can be printed by the printer 2. The PDL data generated by the supporting program 42 may be in a format that can be printed by printers in addition to models of the printer 2.

After encoding, the supporting program 42 determines whether an instruction to set the scaling settings as default has been received. The supporting program 42 allows the user to input an instruction to set the current scaling settings as default, for example, by checking the check box 63 on the advanced settings screen 60 of FIG. 4. In step A23 of FIG. 2, the supporting program 42 also stores information indicating whether an instruction to set the current scaling settings as default has been received.

In a case where an instruction to set the current scaling settings as default has been received (alt: [Set Current Settings as Default]), the supporting program 42 stores the current scaling settings including the scaling factor into a nonvolatile storage area as default (B32). More specifically, for example, the supporting program 42 stores the scaling settings stored in step A23 of FIG. 2 into the nonvolatile storage area. This may thus enable the same scaling factor to be applied as default print settings each time in the future. Therefore, such a configuration may save the user who is to perform printing at the same scaling factor in the future from having to specify the scaling factor every time.

In a case where an instruction to set the current scaling settings as default has not been received (alt: [Not Set Current Settings as Default]), the supporting program 42 initializes the scaling settings without storing the current scaling settings into the nonvolatile storage area (B33). Step B33 is an example of initializing the received scaling factor. Initializing the scaling settings may result in the scaling settings being set to no scaling. For example, the supporting program 42 removes the scaling settings stored in step A23 of FIG. 2 to invalidate the scaling factor received in the current print job. In this case, the current scaling settings are not applied to subsequent print jobs. In the illustrative embodiment, the user is allowed to specify whether the current scaling factor is retained, thereby increasing the convenience of the print settings.

The supporting program 42 may initialize the scaling settings at any time after step B14, in which the supporting program 42 receives the raster data. More specifically, prior to step B15, or subsequent to step B15 and prior to B31, the supporting program 42 may determine whether an instruction to set the current scaling settings as default has been received and execute step B32 or B33.

Subsequent to step B32 or B33, the supporting program 42 passes the PDL data generated in step B31 to the universal printing program 41 and instructs the universal printing program 41 to transmit the PDL data to the printer 2 (B35). Step B35 is an example of causing the printer 2 to perform printing.

In response to the instruction received from the supporting program 42, the universal printing program 41 transmits the PDL data to the printer 2 and instructs the printer 2 to perform printing (B36). In response to the print instruction, the printer 2 performs printing based on the received PDL data (B37). Thus, a printed matter having the image scaled at the scaling factor specified by the user is outputted.

In the illustrative embodiment, the supporting program 42 provides the PDL data to the printer 2 via the universal printing program 41. Nevertheless, in other embodiments, for example, the supporting program 42 may provide a print instruction and print data directly to the printer 2. In still other embodiments, for example, in a case where the print settings include settings for image processing that can be executed by the printer 2, the supporting program 42 may generate a print instruction including the settings for image processing. In this case, after completing the transmission of the print data, the supporting program 42 may notify the universal printing program 41 of the completion of the print data transmission.

As described above, in the illustrative embodiment, the supporting program 42 allows the user to specify a scaling factor for the scaling settings via the advanced settings screen 60 displayed on the user IF 13, and obtains an image scaled at the scaling factor. Further, the supporting program 42 causes the printer 2 to print the image scaled at the scaling factor. Such a configuration may thus enable the PC 1, which does not use a printer driver, to allow the printer 2 to print an image scaled to a size specified by the user, using the universal printing program 41 of the OS 21.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. A plurality of printers, for example, two or more printers may be connected to the PC 1.

The screens to be displayed on the user IF 13 illustrated in the illustrative embodiment are all examples. The words or indications on the screens and the screen layouts, such as the shapes of the objects and the backgrounds on the screen, illustrated in the illustrative embodiment are all examples. For example, FIG. 3 illustrates the print settings screen D2 including a single information display field 52. Nevertheless, the location, shape, size, and/or the number of information display fields 52 are not limited to the example of the illustrative embodiment. The print settings screen D2 might not necessarily include the information display field 52.

The advanced settings screen 60 (refer to FIG. 4) might not necessarily include the check box 63. In a case where the advanced settings screen 60 does not include the check box, in one example, the supporting program 42 may set the current scaling settings as default when the radio button 61 representing “Adjust to” is selected. In another example, the supporting program 42 might not set the current scaling settings as default even when the radio button 61 representing “Adjust to” is selected.

The print execution procedure (refer to FIG. 5) might not necessarily include the data processing executed by the supporting program 42 at step B15. Examples of situations in which the supporting program 42 does not execute the data processing include cases where the printer 2 is a model capable of printing without causing an output error even when the printer 2 receives print data of a size different from the size of the sheet to be used.

The supporting program 42 may obtain the capabilities data of the printer 2 at a timing different from the example illustrated in FIG. 2. In one example, in a case where the supporting program 42 is activated by the universal printing program 41 before the print settings screen D2 (refer to FIG. 3) is displayed, the supporting program 42 may obtain the capabilities data of the printer 2 by requesting the capabilities data from the printer 2 at that timing. In another example, the supporting program 42 may obtain the capabilities data of the printer 2 again after receiving the print execution instruction.

In other embodiments, for example, the universal printing program 41 may also activate the supporting program 42 in a case where the default printer is changed to the printer 2 through the OS 21 by a user's operation after the universal printing program 41 displays the print settings screen D2. In this case as well, for example, the supporting program 42 may display a particular screen that allows the user to specify the scaling settings in the information display field 52.

The supporting program 42 may be activated not only when the “Print” button is selected but also when the printer 2 is specified is the device settings, for example. In this case as well, the supporting program 42 may display a setting screen that allows the user to specify the scaling settings. In a case where the supporting program 42 receives the scaling settings as the device settings, the supporting program 42 stores the received scaling settings as the default print settings.

In the illustrative embodiment, the description has been provided on only the printing operation in which the supporting program 42 is involved. However, the supporting program 42 may be involved in another operation in addition to the printing operation. Any program may be applicable instead of the supporting program 42, as long as the program receives an instruction from the OS 21 or the universal printing program 41 when printing is performed using the universal printing program 41. For example, the alternative program may be a print workflow application (PrintWorkflow) whose specification has been disclosed by Microsoft Corporation.

The manner for activating the supporting program 42 is not limited to the examples in the illustrative embodiment. In one example, the supporting program 42 may be activated in response to an activation instruction received directly from the OS 21. In another example, the supporting program 42 may be a resident program. In a case where the supporting program 42 is a resident program, the supporting program 42 may be configured to behave as described above in response to an activation instruction.

In any flowchart disclosed in the illustrative embodiment, steps may be executed in a different order or in parallel, as long as no contradiction occurs in the contents of the procedures.

The processing in all steps disclosed in the illustrative embodiment may be executed by a single CPU, a plurality of CPUs, hardware, for example, an ASIC, or a combination a CPU and an ASIC. The processing in all steps disclosed in the embodiment may be implemented in various aspects such as a recording medium storing a computer-readable program for executing the processing, or a method.

What is claimed is:

1. A non-transitory computer-readable storage medium for an information processing device, the information processing device including a controller, the non-transitory computer-readable storage medium storing computer-executable instructions for implementing a supporting program for a printer connectable to the information processing device, the supporting program that, when executed by the controller, causes the information processing device to perform:
receiving a scaling factor, the receiving including displaying a setting screen on a user interface of the information processing device to allow specification of the scaling factor through the setting screen,
wherein the information processing device has an operating system including a universal printing program, the information processing device is incorporated with an application program, and
wherein, in response to the universal printing program receiving, from the application program, a print instruction that causes the printer to perform printing, the supporting program, when executed by the controller, causes the information processing device to perform:
obtaining a scaled image, the scaled image being obtained by scaling an image to be printed based on the scaling factor; and
causing the printer to print the obtained scaled image.

2. The non-transitory computer readable storage medium according to claim 1, wherein the obtaining the scaled image includes:
sending, to the universal printing program, a request to rasterize the image to be printed;
obtaining raster data representing the rasterized image to be printed from the universal printing program; and
scaling the raster data based on the scaling factor, thereby obtaining the scaled image.

3. The non-transitory computer readable storage medium according to claim 1, wherein the obtaining the scaled image includes:
sending, to the universal printing program, a parameter and a request to rasterize the image to be printed, the parameter being calculated based on the scaling factor; and
obtaining raster data representing the rasterized image to be printed from the universal printing program.

4. The non-transitory computer readable storage medium according to claim 3,
wherein the parameter is a resolution calculated based on the scaling factor, and
wherein the obtaining the scaled image includes:
sending, to the universal printing program, a request to rasterize the image to be printed at the calculated resolution; and
obtaining raster data representing the rasterized image from the universal printing program.

5. The non-transitory computer readable storage medium according to claim 1, wherein the supporting program, when executed by the controller, causes the information processing device to perform:
adjusting the scaled image to fit a sheet size based on print settings included in the print instruction after the obtaining the scaled image and before the causing the printer to print the obtained scaled image, and
wherein the causing the printer to print the obtained scaled image includes causing the printer to print the adjusted scaled image.

6. The non-transitory computer readable storage medium according to claim 1,
wherein the setting screen provides an option to select whether the scaling factor is retained, and
wherein the supporting program, when executed by the controller, causes the information processing device to perform:
in a case where the option indicates that the scaling factor is not retained, initializing the received scaling factor after the obtaining the scaled image; and
in a case where the option indicates that the scaling factor is retained, omitting the initializing the received scaling factor.
